(19) United States
(12) Patent Application Publication
(10) Pub. No.: US 2021/0209610 A1
(43) Pub. Date: Jul. 8, 2021

(54) IOT BASED QUALITY CHECK AND REFUND AMOUNT COMPUTATION

(71) Applicant: International Business Machines Corporation, Armonk, NY (US)

(72) Inventors: Raghuveer Prasad Nagar, Kota (IN); Jagadesh Ramaswamy Hulugundi, Bangalore (IN)

(21) Appl. No.: 16/736,149

(22) Filed: Jan. 7, 2020

(51) Int. Cl. G06Q 30/00; G06Q 20/40; G16Y 10/45; G16Y 20/10

(52) U.S. Cl. CPC G06Q 30/012; G06Q 20/407; G16Y 20/10; G16Y 10/45; G06Q 30/016

(57) ABSTRACT

Aspects of the present invention disclose a method for computing a refund amount for an item return request based on a real-time quality check using internet of things (IoT) data. The method includes one or more processors detecting a return request of an item. The method further includes retrieving media associated with the item of the return request from one or more IoT enabled devices. The method further includes determining a context of the return request from the retrieved media, wherein the context includes one or more topics of a user interaction. The method further includes determining a state of the item based on the retrieved media, wherein the state of the item indicates a condition of the item. The method further includes determining whether the return request is valid based at least in part on the determined context and the determined state of the item.

### BACKGROUND OF THE INVENTION

The present invention relates generally to the field of machine learning, and more particularly to dynamically performing a quality check of a return item using real-time Internet of Things data.

In recent years, developments and the growth of Internet of Things (IoT) capable devices have created a wealth of opportunities to advance the capabilities to integrate systems. The internet of things (IoT) is the internetworking of physical devices (also referred to as “connected devices” and “smart devices”), vehicles, buildings, and other items, embedded with electronics, software, sensors, actuators, and network connectivity that enable these objects to collect and exchange data. The IoT allows objects to be sensed and/or controlled remotely across existing network infrastructure, creating opportunities for more direct integration of the physical world into computer-based systems, and resulting in improved efficiency, accuracy, and economic benefit in addition to reduced human intervention. Each thing is uniquely identifiable through its embedded computing system but is able to interoperate within the existing Internet infrastructure.

In machine learning and artificial intelligence an important aspect in model creation and training is data quality. Data quality and data cleansing is of paramount significance for machine learning algorithms. If data is not cleansed enough (e.g., includes stale data) machine learning algorithm may not be able to learn (i.e., to converge to minimum of a cost function) or the machine learning algorithm can be required to use more training examples, which results in extended learning time and increased computing resources consumption.

### SUMMARY

Aspects of the present invention disclose a method, computer program product, and system for dynamically computing an estimated refund amount for an item return order or request based on a real-time quality check using internet of things (IoT) data. The method includes one or more processors detecting a return request of an item. The method further includes one or more processors retrieving media associated with the item of the return request from one or more IoT enabled devices. The method further includes one or more processors determining a context of the return request from the retrieved media, wherein the context includes one or more topics of a user interaction. The method further includes one or more processors determining a state of the item based on the retrieved media, wherein the state of the item indicates a condition of the item. The method further includes one or more processors determining whether the return request is valid based at least in part on the determined context and the determined state of the item.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program, within the data processing environment of FIG. 1, for dynamically computing an estimated refund amount for an item return order or request based on a real-time quality check using internet of things (IoT) data, in accordance with embodiments of the present invention.

FIG. 3 is a block diagram of components of the client device, IoT platform, and server of FIG. 1, in accordance with an embodiment of the present invention.

### DETAILED DESCRIPTION

Embodiments of the present invention allow for dynamically computing an estimated refund amount for an item return order or request based on a real-time quality check using internet of things (IoT) data. Embodiments of the present invention compare images of an item captured during return creation with the state of the item when received in a warehouse in order to determine whether a carrier, which may or may not be a customer, should be charged for damage to the item. Embodiments of the present invention dynamically generate a message for a customer based on the quality check status. Additional embodiments of the present invention automatically initiate a return of a delivered item based on an IoT enabled device quality check.

Some embodiments of the present invention recognize that current methodologies for processing refunds due to returns is more reactive in nature. Furthermore, the current methodologies create an undesirable experience for a customer. Therefore, embodiments of the present invention recognize a need for a proactive method to handle the return requests for a refund. Various embodiments of the present invention solve this problem by utilizing one or more IoT enabled devices and artificial intelligence to perform a real-time quality check and dynamically compute an estimated refund amount for an item return order or request.

Various embodiments of the present invention can operate to reduce the volume of customer return requests a server must process, which increases processing resources of the server. Embodiments of the present invention automatically initiate a return of an item damaged in transit to a customer prior to the customer receiving an item. Additionally, embodiments of the present invention automatically retrieve IoT data and utilizes the IoT data in the determination of the validity of the return of an item. Thus, embodiments of the present invention eliminate a customer interaction and the need for a server to execute tasks associated with processing refund and return information of a customer.

Implementation of embodiments of the invention may take a variety of forms, and exemplary implementation details are discussed subsequently with reference to the Figures.

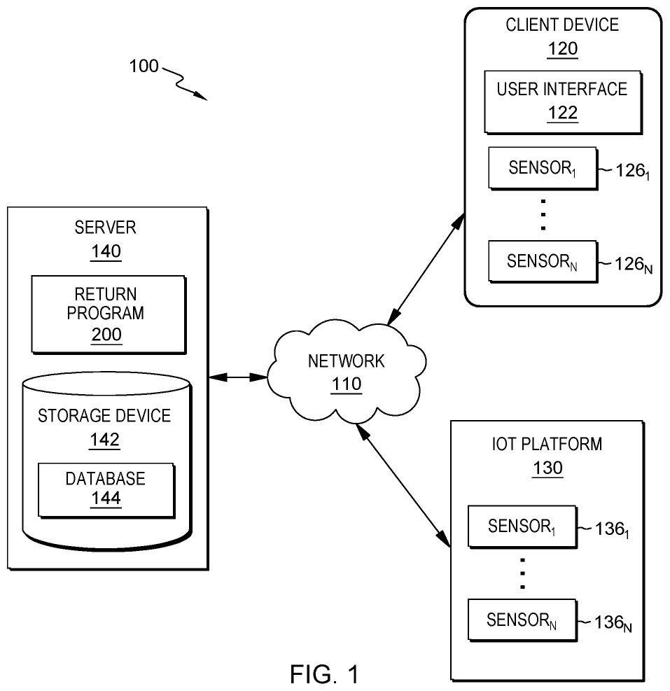

The present invention will now be described in detail with reference to the Figures. FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

The present invention may contain various accessible data sources, such as database 144, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Return program 200 enables the authorized and secure processing of personal data. Return program 200 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Return program 200 provides information regarding personal data and the nature (e.g., type, scope, purpose, duration, etc.) of the processing. Return program 200 provides the user with copies of stored personal data. Return program 200 allows the correction or completion of incorrect or incomplete personal data. Return program 200 allows the immediate deletion of personal data.

Distributed data processing environment 100 includes server 140, client device 120, and internet of things (IoT) platform 130, all interconnected over network 102. Network 110 can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include voice, data, and video information. In general, network 110 can be any combination of connections and protocols that will support communications between server 140, client device 120, IoT platform 130, and other computing devices (not shown) within distributed data processing environment 100.

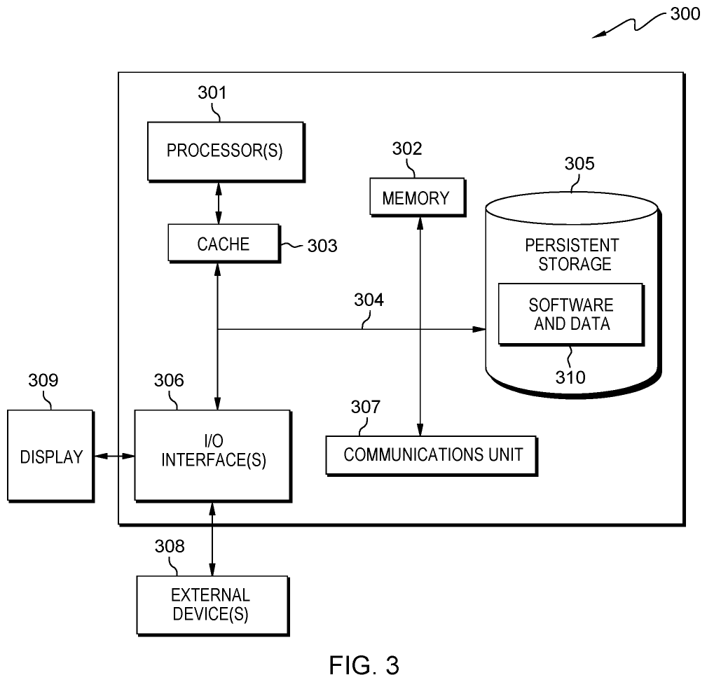

Internet of things (IoT) platform 130 is a suite of components that enable: a) deployment of applications that monitor, manage, and control connected devices and sensors; b) remote data collection from connected devices; and c) independent and secure connectivity between devices. The components may include, but are not limited to, a hardware architecture, an operating system, or a runtime library (not shown). In one embodiment, IoT platform 130 includes sensor 136_{1-N}. In another embodiment, IoT platform 130 may include a plurality of other connected computing devices. For example, IoT platform 130 may include home security devices, such as cameras. In another example, IoT platform 130 may include a shipping and/or packaging monitoring system. In another embodiment, IoT platform 130 can utilize sensor data of a return item. For example, IoT platform 130 can retrieve sensor data (e.g., video data of a camera) of a smart television (e.g., the return item) that is IoT-enabled. IoT platform 130 may include components as depicted and described in further detail with respect to FIG. 3, in accordance with embodiments of the present invention.

Client device 120 can be one or more of a laptop computer, a tablet computer, a smart phone, smart watch, a smart speaker, or any programmable electronic device capable of communicating with various components and devices within distributed data processing environment 100, via network 110. In general, client device 120 represents one or more programmable electronic devices or combination of programmable electronic devices capable of executing machine readable program instructions and communicating with other computing devices (not shown) within distributed data processing environment 100 via a network, such as network 110. Client device 120 may include components as depicted and described in further detail with respect to FIG. 3, in accordance with embodiments of the present invention.

Client device 120 may include one or more speakers, a processor, user interface 122, application 124, and sensor 126_{1-N}. User interface 122 is a program that provides an interface between a user of client device 120 and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122 is a script or application programming interface (API). In yet another embodiment, web user interface (WUI) and can display text, documents, web browser windows, user options, application interfaces, and instructions for operation, and include the information (such as graphic, text, and sound) that a program presents to a user and the control sequences the user employs to control the program.

Application 124 is a computer program designed to run on client device 120. An application frequently serves to provide a user with similar services accessed on personal computers (e.g., web browser, playing music, or other media, etc.). In one embodiment, application 124 is mobile application software. For example, mobile application software, or an “app,” is a computer program designed to run on smart phones, tablet computers and other mobile devices.

A sensor is a device that detects or measures a physical property and then records or otherwise responds to that property, such as vibration, chemicals, radio frequencies, environment, weather, humidity, light, etc. Sensor 126_{1-N} and sensor 136_{1-N}, herein sensor(s) 126 and sensor(s) 136, detect a plurality of attributes of an item (e.g., product, garment, etc.). As used herein, N represents a positive integer, and accordingly the number of scenarios implemented in a given embodiment of the present invention is not limited to those depicted in FIG. 1.

Sensor(s) 126 and sensor(s) 136 may be one or more of a plurality of types of camera, including, but not limited to, pin-hole, stereo, omni-directional, non-central, infrared, video, digital, three dimensional, panoramic, filter-based, wide-field, narrow-field, telescopic, microscopic, etc. In some embodiments, sensor(s) 126 and sensor(s) 136 may be one or more of a plurality of types of microphone for detecting speech and other audible sounds, such as verbal communications of a customer and a customer service representative (CSR). Sensor(s) 126 and sensor(s) 136 may be GPS sensors. Sensor(s) 116 may be integrated into one or more instances of client device 120. Sensor(s) 126 may be integrated into mobile device (e.g., client device 120) that records data corresponding to a customer and a CSR, which may include, but is not limited to, textual data submitted by the customer, audio data corresponding to a customer-CSR interaction, images and/or video data corresponding to an item being returned, whether the customer pays with cash or a credit card, and the amount of money the customer pays for the item.

In various embodiments of the present invention, server 140 may be a desktop computer, a computer server, or any other computer systems, known in the art. In general, server 140 is representative of any electronic device or combination of electronic devices capable of executing computer readable program instructions. Server 140 may include components as depicted and described in further detail with respect to FIG. 3, in accordance with embodiments of the present invention.

Server 140 can be a standalone computing device, a management server, a web server, a mobile computing device, or any other electronic device or computing system capable of receiving, sending, and processing data. In one embodiment, server 140 can represent a server computing system utilizing multiple computers as a server system, such as in a cloud computing environment. In another embodiment, server 140 can be a laptop computer, a tablet computer, a netbook computer, a personal computer (PC), a desktop computer, a personal digital assistant (PDA), a smart phone, or any programmable electronic device capable of communicating with client device 120, IoT platform 130, and other computing devices (not shown) within distributed data processing environment 100 via network 110. In another embodiment, server 140 represents a computing system utilizing clustered computers and components (e.g., database server computers, application server computers, etc.) that act as a single pool of seamless resources when accessed within distributed data processing environment 100.

Server 140 includes storage device 142, database 144, and return program 200. Storage device 142 can be implemented with any type of storage device, for example, persistent storage 305, which is capable of storing data that may be accessed and utilized by server 140, IoT platform 130, and client device 120, such as a database server, a hard disk drive, or a flash memory. In one embodiment storage device 142 can represent multiple storage devices within server 140. In various embodiments of the present invention storage device 142 stores a plurality of information, such as database 144.

Database 144 may represent one or more organized collections of data stored and accessed from server 140. In one embodiment, database 144 includes data associated with a return transaction of an item. For example, database 144 may include textual data submitted by the customer, audio data corresponding to a customer-CSR interaction, images and/or video data corresponding to an item being returned, whether the customer pays with cash or a credit card, and the amount of money the customer pays for the item, etc., corresponding to a return transaction initiated with client device 120. In another embodiment, data processing environment 100 can include additional servers (not shown) that host additional information that accessible via network 110.

Generally, return program 200 proactively performs a quality check of a return request or item order prior to transmitting confirmation of the return to a customer utilizing data feeds of IoT enabled devices and artificial intelligence. In various embodiments of the present invention, return program 200 may be implemented in numerous channels (e.g., call center, store, self-service portal, etc.) in which a return may be initiated. In one embodiment, return program 200 utilizes data of IoT platform 130 to perform a quality check of an item. For example, return program 200 analyses real-time video of an item from a camera of a mobile device of a user to determine whether the item is damaged.

In another embodiment, return program 200 determines a refund amount of an item. For example, return program 200 compares captured media (e.g., images, customer description of problem) during return creation with a current state of an item in order to determine whether a carrier, which may or may not be the customer, should be assessed a return mishandling charge. In another embodiment, return program 200 provides a notification to a customer via client device 120. For example, return program 200 displays a message to a customer or CSR that includes a validation status, mishandling fee, return processing fee, and/or overall refund amount.

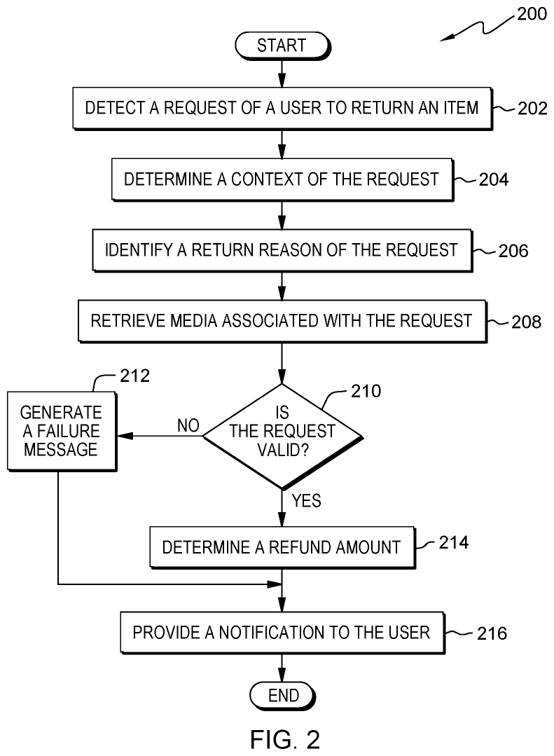

FIG. 2 is a flowchart depicting operational steps of return program 200, a program to dynamically compute an estimated refund amount for an item return order or request based on a real-time quality check using internet of things (IoT) data, in accordance with embodiments of the present invention. In one embodiment, return program 200 initiates in response to client device 120 receiving a return request of a user. For example, return program 200 initiates when a computing device (e.g., client device 120) receives details corresponding to a return request of an item from a CSR. In another embodiment, return program 200 is continuously monitoring client device 120. For example, return program 200 is constantly monitoring a kiosk (e.g., client device 120) for a customer to initiate a return request.

In step 202, return program 200 detects a request of a user to return an item. In one embodiment, return program 200 detects a return request of a user on client device 120. For example, a CSR receives a call from a customer requesting a return of a smart television, return program 200 monitors a computing device (e.g., client device 120) of the CSR to determine whether the CSR initiates a return request by detecting that the CSR is opening a client-side application (e.g., application 124) of return program 200 on the computing device. In another example, return program 200 is constantly monitoring a WUI of a kiosk (e.g., client device 120) to detect a customer initiating a return request.

In step 204, return program 200 determines a context of the request. In one embodiment, return program 200 utilizes sensor(s) 126 to determine a context of a return request. For example, return program 200 utilizes a microphone (e.g., sensor(s) 126) of a computing device to record interactions between a customer and a CSR. In this example, return program 200 uses speech-to-text conversion techniques to generate a textual representation of the recording/call of the interaction, and then uses natural language processing (NLP) techniques to gather more information (e.g., type of item, damage, problem, etc.) that the customer reports in a return request. Additionally, return program 200 uses NLP techniques on information the CSR enters in a return request and notes logged by the customer on a kiosk or on the notes logged by the CSR on a computing device. In another embodiment, return program 200 utilizes IoT platform 130 to determine a context of a return request.

In step 206, return program 200 identifies a return reason of the request. In one embodiment, return program 200 determines a return reason using collected data of sensor(s) 126. For example, return program 200 parses a textual representation of logged notes, return request forms, and/or a recording/call of an interaction of a customer and CSR and uses semantic techniques of NLP (e.g., natural language understanding, lexical semantics, etc.) to identify a reason for return of an item. In this example, in the textual representation of a recording/call of the interaction, return program 200 identifies that the customer provided a response to an inquiry of the CSR that “a camera recording of a smart television is not clear, that is, the recorded/captured videos are blurred.” Furthermore, return program 200 identifies, in the text of the notes logged by the CSR, that the customer that provided that the smart television (e.g., the item) is damaged as a reason for return. Additionally, return program 200 determines that a damaged camera of the smart television is the reason for return. In another embodiment, return program 200 determines a return reason utilizing data provided to a CSR from a customer via client device 120.

In step 208, return program 200 retrieves media associated with the request. In various embodiments of the present invention, a user consents (e.g., opt-in) to providing return program 200 permission to retrieve and store data of IoT enabled devices of the user, including a return item, in order to validate a return request. In one embodiment, return program 200 retrieves media of sensor(s) 136 of IoT platform 130. For example, return program 200 retrieves visual data (e.g., images, videos, etc.) of data feeds IoT enabled devices that include an item corresponding to a return request of a user. In this example, a customer authorizes (i.e., registers or opted in) return program 200 to access and process data of a security camera (e.g., sensor 136₁) of a smart television and a web camera (e.g., sensor 136_{N}) of the customer. Also, return program 200 accesses the security camera of the smart television (i.e., the item of the return request) and the web camera of the customer that includes the smart television in a field of view of the web camera. Additionally, return program 200 retrieves images of video data of the security camera of the smart television.

In another embodiment, return program 200 retrieves media from database 144. For example, return program 200 retrieves images of a smart television a customer uploads to a profile (i.e., registered with return program 200) on a remote server that correspond to a return request of the customer. In another example, return program 200 retrieves images of a smart television from a website database of a remote server (e.g., server 140) that includes stock images and descriptions of the smart television based on model information of the smart television. In yet another example, return program 200 extracts a customer provided return reason (e.g., blurry images) from a return request using NLP techniques. In this example, return program 200 uses NLU techniques on the return reason to identify an IoT sensor type (e.g., sensor(s) 136) associated with the return reason (i.e., blurry images are associated with a camera). Additionally, return program 200 identifies available IoT enabled devices with cameras and retrieves data (e.g., images) that associated with the return reason of a delivery item.

In decision step 210, return program 200 determines whether the request is valid. In one embodiment, return program 200 utilizes IoT data (e.g., IoT platform 130, sensor(s) 126, etc.) to determine whether a customer provided return reason is valid. For example, return program 200 retrieves a return reason of a user (as discussed in step 206) and performs a quality check of a return item using real-time IoT data (e.g., IoT platform 130, sensor(s) 126, etc.) to validate the return reason. Additionally, the real-time IoT data may include text data, images, videos or any data stored in a database (e.g., database 144). Furthermore, return program 200 may capture visual data (e.g., images, videos, etc.) from a smart television (e.g., client device 120) or a webcam (e.g., sensor(s) 136) and verify the return reason using the captured visual data.

If return program 200 determines that a customer-provided return reason is not valid (decision step 210, “NO” branch), then return program 200 generates a failure message (as described in step 212). In one scenario, if return program 200 retrieves images of a security camera (e.g., sensor 136₁) of a smart television, which are blurred, and a web camera (e.g., sensor 136_{N}) of a customer that includes the smart television in a field of view of the web camera, and detects that the security camera film is still in place, then return program 200 determines that a customer return reason (e.g., damaged smart television) is invalid and processes the customer return reason as invalid.

Additionally, return program 200 stores validation failure details in a database to form a message to convey to the customer (as discussed in step 212). In another scenario, if the customer reports the reason of return as “smart television overheats quickly,” then return program 200 determines that a batch number is required, which is an inventory attribute that may not be available on a corresponding sales order, and can either generate a message requesting a serial number of the smart television or proceed with the refund amount calculation.

If return program 200 determines that a customer-provided return reason is valid (decision step 210, “YES” branch), then return program 200 determines a refund amount for a return request. In one scenario, return program 200 retrieves images of a web camera (e.g., sensor 136_{N}) of a customer that includes the smart television in a field of view of the web camera. Return program 200 can compare the retrieved images to stock images of the smart television and detect that the security camera lens is scratched (e.g., irregularity). Accordingly, return program 200 determines that a customer return reason (e.g., damaged smart television) is valid and initiates computing a refund amount of the smart television.

In step 212, return program 200 generates a failure message. In one embodiment, return program 200 utilizes data of database 144 to generate a failure message for a user. For example, return program 200 extracts attributes from media that caused validation of a customer return reason to fail. In one scenario, return program 200 determines that the validation fails because the customer reported a blue smart television, but based on data of a webcam of the customer (i.e., real-time IoT data) a color (e.g., black) of the smart television is found correct during validation based on text of an order form. In this scenario, return program 200 extracts color as an attribute, and then processes extracted attributes for message text synthesis. In this example, return program 200 may generate a failure message as either text, audio, or video. Additionally, for delivering non-textual forms of audio or video of the generated message, return program 200 can utilize text-to-speech techniques to provide the generated message to the customer.

In another example, return program 200 may fail to validate a customer return reason due to unavailability of complete information. Additionally, return program 200 determines information that is required and then generates a message accordingly. In this example, a customer reports a reason of return as a smart television overheats within few minutes of use. Then, return program 200 fails to locate data (e.g., batch number, serial number, etc.), determines that validation information is unavailable, and generates a message that requests the validation information from a user. Also, return program 200 can provide the customer an option to upload images or videos of the smart television (e.g., return item) in order to complete validation (as discussed in step 210).

In step 214, return program 200 determines a refund amount. In various embodiments of the present invention, return program 200 utilizes media (e.g., real-time IoT data, customer provided, etc.), return history of an item, and return policy, which includes reason for return, to compute a refund amount for the item. In one embodiment, return program 200 utilizes data of database 144 and IoT platform 130 to determine a refund amount for a return item. For example, a customer completes a return request for a recently bought smart television (e.g., return item) with a return reason as “Change of Mind.” In this example, return program 200 retrieves the real-time video of the smart television from a webcam of the customer, which shows that the smart television has a deep scratch that was not present at the time of delivery/installation. Additionally, return program 200 retrieves the policy for return of damaged goods from a database (e.g., database 144), accordingly adds a return processing fee to be deducted from a price the customer paid for the smart television (i.e., the customer gets a partial refund).

In another example, a customer completes a return request for a recently bought smart television (e.g., return item) with a return reason as “Change of Mind.” Return program 200 access a webcam of the customer to capture images of the smart television at the time the return request is completed and stores the images in a database (e.g., database 144). In this example, upon receipt of the smart television in a return location, return program 200 accesses a security camera (e.g., sensor(s) 136) at the return location to capture images of the smart television to compare (e.g., image to image comparison, frame to frame comparison, etc.) with images stored in the database to determine whether the smart television has been damaged in transit to the return location. Additionally, return program 200 identifies a deep scratch in the smart television, determines that the smart television was damaged by a transporter (e.g., the customer, a third-party delivering company, etc.), and assesses a return mishandling charge to the transporter.

In step 216 return program 200 provides a notification to the user. In one embodiment, return program 200 provides a notification to a user via a computing device (not shown). For example, return program 200 transmits a validation failure message (generated in step 210) to a customer via a WUI of a mobile device (e.g., computing device) of the customer. In another example, return program 200 transmits a return confirmation notification of the return request to a customer via a client-side application (e.g., the WUI) of return program 200 on the mobile device (e.g., computing device) of the customer. In this example, the return confirmation notification can include the refund amount corresponding to the return request.

In another embodiment, return program 200 automatically initiates a return request of one or more items. For example, return program 200 transmits a return confirmation notification to a user prior to completion of delivery of one or more items. In this example, if return program 200 utilizes a camera feed of IoT-enabled camera in a shipping processing facility to determine that five (5) of twelve (12) items of an order are damaged, then return program 200 can automatically initiate a return for the damaged items and transmit a confirmation message to the customer that includes a status of the order. Additionally, the confirmation message can include an option to order replacements for the damaged items or accept a partial refund based on the damaged items and price of the customer paid for the order.

FIG. 3 depicts a block diagram of components of client device 120, IoT platform 130, and server 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

FIG. 3 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to client device 120, software and data 310 includes data of user interface 122, application 124, and sensor(s) 126. With respect to IoT platform 130, software and data 310 includes data of sensor(s) 136. With respect to server 140, software and data 310 includes data of storage device 142 and return program 200.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
detecting, by one or more processors, a return request of an item;
retrieving, by one or more processors, media associated with the item of the return request from one or more internet of things (IoT) enabled devices;
determining, by one or more processors, a context of the return request from the retrieved media, wherein the context includes one or more topics of a user interaction corresponding to the return request;
determining, by one or more processors, a state of the item based on the retrieved media, wherein the state of the item indicates a condition of the item at a defined time; and
determining, by one or more processors, whether the return request is valid based at least in part on the determined context and the determined state of the item.

2. The method of claim 1, further comprising:
in response to determining that the return request is valid based at least in part on the determined context and the determined state of the item, computing, by one or more processors, a refund of the item of the return request.

3. The method of claim 1, further comprising:
in response to determining that the return request is valid based at least in part on the determined context and the determined state of the item, generating, by one or more processors, a message for a user associated with the return request, wherein a form of the message is selected from a group consisting of: text, audio, and video; and
providing, by one or more processors, the message to the user.

4. The method of claim 1, further comprising:
in response to determining that the return request is valid based at least in part on the determined context and the determined state of the item, initiating, by one or more processors, a return of the item.

5. The method of claim 1, wherein determining the context of the return request from the retrieved media, further comprises:
collecting, by one or more processors, textual data corresponding to the user interaction corresponding to the return request;
collecting, by one or more processors, audio data of the user interaction corresponding to the return request;
generating, by one or more processors, a textual representation of the audio data of the user interaction corresponding to the return request; and
determining, by one or more processors, information from the textual representation and the collected textual data, wherein the information is selected from a group consisting of:
return reason, item type, damage, issue, and additional notes.

6. The method of claim 1, wherein determining the state of the item based on the retrieved media, further comprises:
retrieving, by one or more processors, the media of the IoT enabled devices that includes the item, wherein the media includes videos and images of the item;
retrieving, by one or more processors, an image of the item at a time of delivery;
comparing, by one or more processors, the media of the IoT enabled devices that includes the item to the image of the item at the time of delivery; and
determining, by one or more processors, whether the media of the IoT enabled devices that includes the item includes an irregularity of the item that is not present in the image of the item at the time of delivery.

7. The method of claim 1, wherein determining whether the return request is valid based at least in part on the determined context and the determined state of the item, further comprises:
retrieving, by one or more processors, a user-provided return reason from the return request;
retrieving, by one or more processors, the context of the return request; and
determining, by one or more processors, an inconsistency between the context and the user-provided return of the return request.

8. A computer program product comprising:
one or more computer readable storage media and program instructions stored on the one or more computer readable storage media, the program instructions comprising:
program instructions to detect a return request of an item;
program instructions to retrieve media associated with the item of the return request from one or more internet of things (IoT) enabled devices;
program instructions to determine a context of the return request from the retrieved media, wherein the context includes one or more topics of a user interaction corresponding to the return request;
program instructions to determine a state of the item based on the retrieved media, wherein the state of the item indicates a condition of the item at a defined time; and
program instructions to determine whether the return request is valid based at least in part on the determined context and the determined state of the item.

9. The computer program product of claim 8, further comprising program instructions, stored on the one or more computer readable storage media, to:
in response to determining that the return request is valid based at least in part on the determined context and the determined state of the item, compute a refund of the item of the return request.

10. The computer program product of claim 8, further comprising program instructions, stored on the one or more computer readable storage media, to:
in response to determining that the return request is valid based at least in part on the determined context and the determined state of the item, generate a message for a user associated with the return request, wherein a form of the message is selected from a group consisting of: text, audio, and video; and
provide the message to the user.

11. The computer program product of claim 8, further comprising program instructions, stored on the one or more computer readable storage media, to:
in response to determining that the return request is valid based at least in part on the determined context and the determined state of the item, initiate a return of the item.

12. The computer program product of claim 8, wherein program instructions to determine the context of the return request from the retrieved media, further comprise program instructions to:
collect textual data corresponding to the user interaction corresponding to the return request;
collect audio data of the user interaction corresponding to the return request;
generate a textual representation of the audio data of the user interaction corresponding to the return request; and
determine information from the textual representation and the collected textual data, wherein the information is selected from a group consisting of: return reason, item type, damage, issue, and additional notes.

13. The computer program product of claim 8, wherein program instructions to determine the state of the item based on the retrieved media, further comprise program instructions to:
retrieve the media of the IoT enabled devices that includes the item, wherein the media includes videos and images of the item;
retrieve an image of the item at a time of delivery;
compare the media of the IoT enabled devices that includes the item to the image of the item at the time of delivery; and
determine whether the media of the IoT enabled devices that includes the item includes an irregularity of the item that is not present in the image of the item at the time of delivery.

14. The computer program product of claim 8, wherein program instructions to determine whether the return request is valid based at least in part on the determined context and the determined state of the item, further comprise program instructions to:
retrieve a user-provided return reason from the return request;
retrieve the context of the return request; and
determine an inconsistency between the context and the user-provided return of the return request.

15. A computer system comprising:
one or more computer processors;
one or more computer readable storage media; and
program instructions stored on the computer readable storage media for execution by at least one of the one or more processors, the program instructions comprising:
program instructions to detect a return request of an item;
program instructions to retrieve media associated with the item of the return request from one or more internet of things (IoT) enabled devices;
program instructions to determine a context of the return request from the retrieved media, wherein the context includes one or more topics of a user interaction corresponding to the return request;
program instructions to determine a state of the item based on the retrieved media, wherein the state of the item indicates a condition of the item at a defined time; and
program instructions to determine whether the return request is valid based at least in part on the determined context and the determined state of the item.

16. The computer system of claim 15, further comprising program instructions, stored on the one or more computer readable storage media for execution by at least one of the one or more processors, to:
in response to determining that the return request is valid based at least in part on the determined context and the determined state of the item, compute a refund of the item of the return request.

17. The computer system of claim 15, further comprising program instructions, stored on the one or more computer readable storage media for execution by at least one of the one or more processors, to:
in response to determining that the return request is valid based at least in part on the determined context and the determined state of the item, generate a message for a user associated with the return request, wherein a form of the message is selected from a group consisting of: text, audio, and video; and
provide the message to the user.

18. The computer system of claim 15, further comprising program instructions, stored on the one or more computer readable storage media for execution by at least one of the one or more processors, to:
in response to determining that the return request is valid based at least in part on the determined context and the determined state of the item, initiate a return of the item.

19. The computer system of claim 15, wherein program instructions to determine the context of the return request from the retrieved media, further comprise program instructions to:
collect textual data corresponding to the user interaction corresponding to the return request;
collect audio data of the user interaction corresponding to the return request;
generate a textual representation of the audio data of the user interaction corresponding to the return request; and
determine information from the textual representation and the collected textual data, wherein the information is selected from a group consisting of: return reason, item type, damage, issue, and additional notes.

20. The computer system of claim 15, wherein program instructions to determine the state of the item based on the retrieved media, further comprise program instructions to:
retrieve the media of the IoT enabled devices that includes the item, wherein the media includes videos and images of the item;
retrieve an image of the item at a time of delivery;
compare the media of the IoT enabled devices that includes the item to the image of the item at the time of delivery; and
determine whether the media of the IoT enabled devices that includes the item includes an irregularity of the item that is not present in the image of the item at the time of delivery.
